(19) United States
(12) Patent Application Publication
(10) Pub. No.: US 2026/0080428 A1
(43) Pub. Date: Mar. 19, 2026

(54) INTEGRATION OF MULTIPLE PRIORS INTO MEDIA MIX MODELING

(71) Applicant: Adobe Inc., San Jose, CA (US)

(72) Inventors: Yancheng Li, Santa Clara, CA (US); Zhenyu Yan, Cupertino, CA (US); Yuan Yuan, San Jose, CA (US); Yiming Xu, Sunnyvale, CA (US); Qilong Yuan, San Jose, CA (US); Lijing Wang, Redwood City, CA (US); Kimberly Leung, Austin, TX (US); Jin Xu, San Jose, CA (US); Bowen Wang, Milpitas, CA (US); Bei Huang, Mountain View, CA (US)

(73) Assignee: Adobe Inc., San Jose, CA (US)

(21) Appl. No.: 18/887,893

(22) Filed: Sep. 17, 2024

(51) Int. Cl. G06Q 30/0204

(52) U.S. Cl. CPC G06Q 30/0205

(57) ABSTRACT

In integrating multiple priors into media mix modeling, a processing device receives multiple priors that each includes contribution share for one or more marketing channels, a time period, and a geographical region. A machine-learning model generates a transferred model for each prior by performing hyperparameter tuning of a base model based on the corresponding contribution share. The processing device uses the transferred models to generate a combined prior that includes a proportional contribution of the multiple priors. The machine-learning model then generates a combined model by performing hyperparameter tuning of the base model using the combined prior. Marketers can utilize the combined model to assess the contribution of different marketing efforts and perform budget planning.

### BACKGROUND

Media mix modeling (MMM) is a statistical technique to determine resource allocation. Media mix modeling uses aggregated time-series data (e.g., weekly-level clicks or impression volumes) and priors (e.g., a belief on channel contributions) to examine the outcome (e.g., conversions) of marketing efforts. Companies often use media mix models to understand the impact of each media channel on sales and brand awareness. Generally, the evaluation process involves constructing a model based on available data, priors, and business assumptions. Because multiple data and priors are often available with different channels, times, or geographical coverages, media mix models often do not accurately assess the contributions from each data set or prior.

### SUMMARY

Techniques and systems for integrating multiple priors into media mix modeling are described. In one example, a processing device receives multiple priors, with each prior including marketing information or contribution share for one or more marketing channels, a certain time period, and a geographical region. For example, the priors include marketing experiments, third-party publisher reports, past modeling results, or spend-share information for a company. For each prior, a machine-learning model performs hyperparameter tuning of a base model to generate a corresponding transferred model. The base model provides a generalized assessment of the impact of different marketing channels on sales. For each prior, the transferred model optimizes or updates the base model based on the corresponding marketing information. To generate the transferred model, the machine-learning model balances a goodness-of-fit over a training window and the distance between expected and predicted marketing contributions.

The processing device uses the transferred models to generate a combined prior that includes a proportional contribution of the multiple priors. The machine-learning model then generates a combined model by performing hyperparameter tuning of the base model using the combined prior. Marketers for the company utilize the combined model to evaluate the contribution of different marketing efforts and allocate resources.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for integrating multiple priors into media mix modeling as described herein.

FIG. 2 depicts a system of an example implementation to integrate multiple priors into media mix modeling as described herein.

FIG. 3 depicts a procedure in an example implementation of multiple prior integration in media mix modeling.

FIG. 4 illustrates an example system including various components of an example device that can be implemented as any type of computing device as described and/or utilized with reference to FIGS. 1-3 to implement embodiments of the techniques described herein.

### DETAILED DESCRIPTION

### Overview

As described above, media mix modeling examines the effectiveness of marketing efforts using aggregated data and/or priors. A model is constructed based on the aggregated data or priors, which is then used to evaluate the contribution of different marketing tactics and allocate resources. However, marketers often have multiple prior sources, including marketing experiments, third-party publisher reports, past modeling results, and spend-share information. With the varied data, marketers often cannot build an inclusive model that integrates the priors well. The described techniques and systems provide a framework for integrating multiple priors in media mix modeling.

Companies use media mix modeling to demonstrate the impact of their marketing efforts and maximize the return on advertising spend (ROAS). These objectives have led companies to increasingly use matched market tests to analyze how well different marketing strategies work. Measurement tools and frameworks integrating matched market tests and other priors facilitate more informed business decisions and efficient resource allocation. However, the increasing number and variety of priors increase the complexity of integrating the available priors to generate reliable and accurate models.

A conventional technique for media mix modeling involves merging multiple priors into a single, cohesive data source based on domain knowledge and industrial expertise. The consolidated data is incorporated into the modeling process using Bayesian or model calibration techniques. The conventional Bayesian technique is highly sensitive to the chosen priors. For example, if a particular prior is not well-calibrated or informative, the prior skews the results, leading to incorrect observations and inefficient resource allocation.

On the other hand, conventional calibration techniques struggle to find an optimal balance when priors conflict. In many scenarios, these conventional techniques involve manual model adjustments to address the conflict, which is often time-consuming and introduces subjectivity. Because it is difficult to accurately weigh each prior during calibration without introducing bias, these conventional calibration techniques generate inaccurate models.

Another conventional technique involves constructing separate models for each prior or subset of priors, with each model leveraging different inputs and data preprocessing workflows. The models are consolidated during an insight review stage using analytical tools, reports, and dashboards to synthesize the combined results. However, integrating outputs from different models is often complex, especially given model structure and output format differences.

In contrast, the described systems and techniques integrate priors from multiple sources into a single model. For example, an end-to-end framework integrates information about marketing channel efficiency and causal-oriented marketing experiment results into the media mix model. The described framework provides both usability and scalability flexibility to facilitate quicker modeling, especially as new marketing channels are introduced and priors are generated.

The proposed framework ensures an objective and unbiased calibration of the media mix model using multiple data sources. Unlike conventional techniques that rely heavily on domain experts to merge different data sets and priors into a single prior with subjective assumptions and potentially introducing biases, the described techniques integrate multiple priors with numerical optimization. This data-driven approach provides an objective calibration process, mitigates the risk of skewed results, and proportionally incorporates the underlying data to improve the reliability and accuracy of model-based insights.

The following discussion describes an example environment that employs the techniques described herein. Example procedures that are performable in the example environment and other environments are also described. Consequently, the performance of the example procedures is not limited to the example environment, and the example environment is not limited to the performance of the example procedures.

### Example Environment

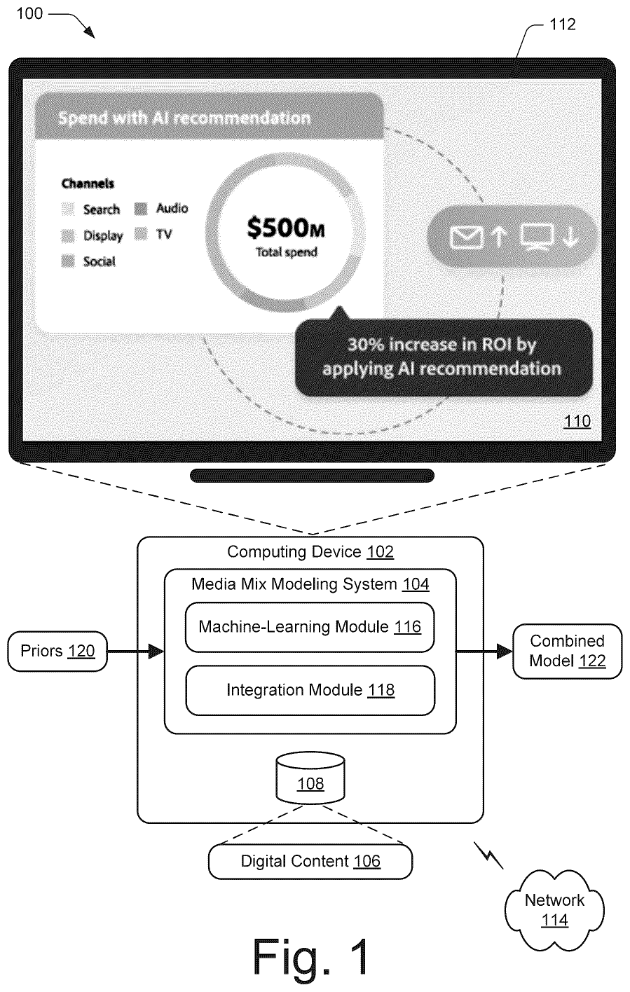

FIG. 1 is an illustration of a digital medium environment 100 in an example implementation that is operable to employ techniques and systems for integrating multiple priors into media mix modeling as described herein. The illustrated digital medium environment 100 includes a computing device 102, which is configurable in various ways.

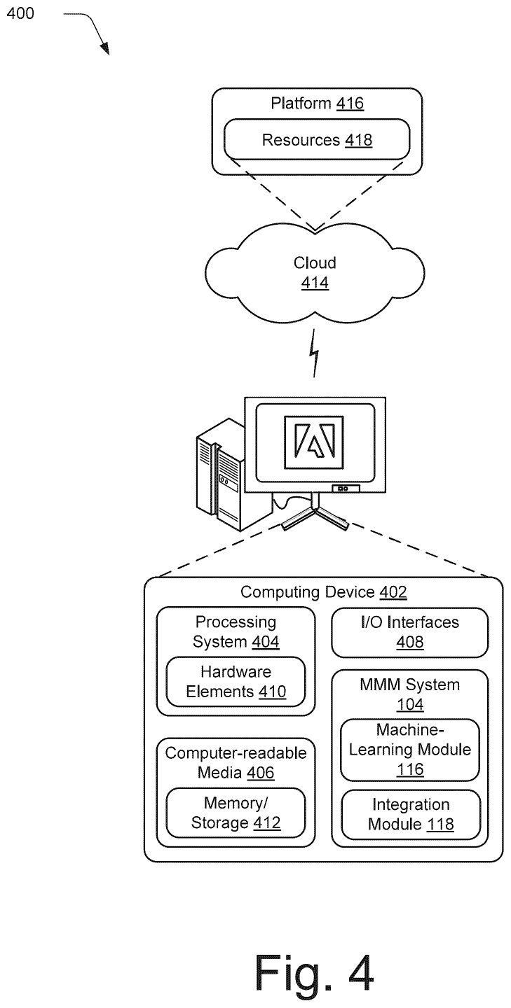

The computing device 102, for instance, is configurable as a desktop computer, a laptop computer, a mobile device (e.g., assuming a handheld configuration such as a tablet or mobile phone), an augmented reality device, and so forth. Thus, computing device 102 ranges from full-resource devices with substantial memory and processor resources (e.g., personal computers and game consoles) to a low-resource device with limited memory and/or processing resources (e.g., mobile devices). Additionally, although a single computing device 102 is shown, the computing device 102 is also representative of a plurality of different devices, such as multiple servers a business utilizes to perform operations “over the cloud” as described in FIG. 4.

The computing device 102 also includes a media mix modeling (MMM) system 104 to assess the impact of marketing efforts and generate strategic marketing budgets. The MMM system 104 is implemented at least partially in the hardware of the computing device 102 to process and represent digital content 106, illustrated as maintained in storage 108 of the computing device 102. Such processing includes creating the digital content 106, representing the digital content 106, modifying the digital content 106, and rendering the digital content 106 for display in a user interface 110 for output, e.g., by a display device 112. Although illustrated as implemented locally at the computing device 102, functionality of the MMM system 104 is also configurable entirely or partially via functionality available via the network 114, such as part of a web service or “in the cloud.”

The computing device 102 also includes a machine-learning module 116 and an integration module 118, illustrated as incorporated by the MMM system 104 to process the digital content 106 and priors 120. In some examples, the machine-learning module 116 and the integration module 118 are separate from the MMM system 104 such as in an example in which data alignment, transfer learning, and/or refinement features of the machine-learning module 116 and the integration module 118, respectively, are available via the network 114.

The MMM system 104 provides a systematic framework to analyze the performance of different marketing channels using aggregated marketing data and priors. For example, the MMM system 104 assesses the marketing contributions reflected in various data sets and priors and assists with resource allocation. The MMM system 104 receives aggregated data and priors 120, which often cover different time periods, marketing channels, and geographical areas.

Predicted marketing contributions often deviate from a marketing team's expectations. Conventional techniques incorporate expectations generated from past modeling experiences, marketing spend share, or select marketing experiments. In these scenarios, user expectations guide and bias model building. However, translating such expectations into tangible, statistical guidelines for the initial model-building process is difficult and prone to inaccurate assumptions.

In contrast, the machine-learning module 116 performs transfer learning on each prior 120 to generate individualized transferred models. The machine-learning module 116 uses a base model that is generated using a set of (cleaned) marketing data and business assumptions as training data. Each transferred model quantifies the relationship between the goodness-of-fit for that model over the entire training window and the distance between fitted channel contributions (as predicted by the base model) and the prior's marketing data provided for its corresponding time window.

The integration module 118 integrates the priors 120 by combining the corresponding transferred models into a combined model 122 for downstream analysis by the machine-learning module 116. In this way, the MMM system 104 offers flexibility in terms of marketing channels, time coverage, and/or geographical coverage to generate the combined model 122 without overreliance on manual tuning, but the MMM system 104 allows marketers to include confidence levels and source weights associated with the priors 120. In addition, the combined model 122 provides a stable assessment of marketing channel contributions by accounting for the variation of external factors and isolating the marginal effects of different marketing efforts. Lastly, new marketing channels with limited historical data are integrated into the combined model 122 utilizing the machine-learning module 116 without many assumptions.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Integrating Multiple Priors

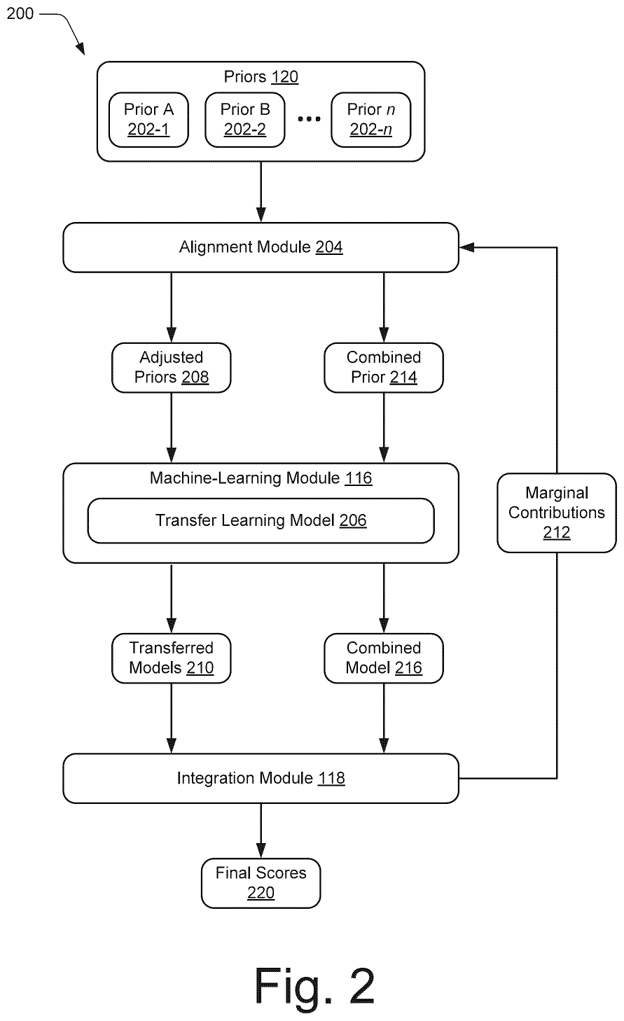

FIG. 2 depicts a system 200 of an example implementation to integrate multiple priors into media mix modeling as described herein. The following discussion describes implementable techniques utilizing the previously described systems and devices. Aspects of each procedure or operation are implemented in hardware, firmware, software, or a combination thereof.

Priors 120, which are inputs to the system 200, include Prior A 202-1, Prior B 202-2, and Prior n 202-n, where n is a positive integer. The number of priors 120 can vary between two to dozens or even more. Priors 120 include marketing data (e.g., contribution share(s)) from different sources, different time windows, different marketing channels, or different geographical regions. For example, the data sources include marketing experiments, A-B testing, matched market testing, third-party publisher reports, past modeling results, or spend-share information. Accordingly, the priors 120 often cover different time periods, marketing channels, and geographical areas than a base model of the machine-learning module 116.

The system 200 includes an alignment module 204, the machine-learning module 116 with a transfer learning model 206, and the integration module 118. Because the priors 120 generally have different time, channel, or geographical coverage than the base media mix model for the machine-learning module 116, the alignment module 204 generalizes the priors 120 to align their granularity or coverage with the base model. For example, marketing experiments (e.g., A/B tests or match market tests) generally assess marketing channel performance within a designated marketing area (e.g., a state or country region), but the base model of the machine-learning module 116 is often built on the country or continent level. If Prior A 202-1 covers California state, the alignment module 204 maps or projects the marketing data to the geographical coverage of the base model (e.g., the United States). The alignment module 204 projects (as necessary) the coverage of each prior 120, whether partial or full, along each dimension to generate adjusted priors 208. In one implementation, the geographical coverage of the priors 120 is aligned with that of the base model, but the time and channel coverage can remain partially aligned. In other implementations, the alignment module 204 projects out each prior 120 to have full alignment along the time, channel, and geographical coverage with the base model.

The transfer learning model 206 performs transfer learning independently on each adjusted prior 208. For each adjusted prior 208, the transfer learning model 206 builds and learns a transferred model 210 guided by the contribution share of the corresponding prior 120. The hyperparameter tuning framework of the transfer learning model 206 quantifies the relationship between two objectives: the model goodness-of-fit (e.g., using R-squared, mean squared error, root mean squared error, mean absolute error, or another statistical measure) over the entire training window and the distance between the fitted-channel contribution (as predicted by the base model) and the prior within the corresponding window. The model tuning balances the trade-off between these two objectives to find a transferred model 210 on the Pareto frontier using the following equation:

$${min}_{β} {\sum }_{j = 1}^{g} {( {\sum }_{s ϵ {T}_{p}} {c}_{j , s} ( β , X ) - {\sum }_{s ϵ {T}_{p}} {\tilde{c}}_{j , s} )}^{2} + λ {\sum }_{t ϵ T} {( {\hat{y}}_{t} ( β ) - {y}_{t} )}^{2}$$

In the equation above, β represents the model parameters of the base model, T represents the full training window of the base model, and Tₚ is the time coverage of the prior 120, which is a subset of the training window. c_{j,s}(β, X) is the marketing contribution for channel j for a unit period as a function of β and X. Σ_{sϵT}_{ₚ} \tilde{c}_{j,s} is the expected total marketing contribution from channel j during the active prior window. yₜ is the actual conversion in time period t. ŷₜ(β) is the predicted conversion of time period t. The first part of the objective quantifies the distance between the expected and the predicted marketing contributions for the period of time covered by prior knowledge. The second summation represents the model goodness-of-fit. A non-negative hyperparameter λ balances the model fit and closeness towards the expected contribution.

Parameter estimates, β₀, from the base model are used as initial values of the optimization problem. The machine-learning module 116 does not request specific forms for the model (represented by ŷₜ(β)) or the marketing contribution computation (represented by c_{j,s}(β)).

To reduce the complexity of the objective function, the machine-learning module 116 uses and optimizes a surrogate function with more tractable gradient computation compared to the objective function. The surrogate function approximates the objective function well when ŷᵢ(β)≈yᵢ, which condition is achieved by sizing the hyperparameter λ.

The transferred model 210 is an optimization of the base model that provides marketing contributions that are close to expectations, as reflected in the corresponding prior 120. In response to receiving confidence ranking scores for the priors 120, the machine-learning module 116 uses these confidence ranking scores to guide the model tuning process.

For each transferred model 210, the integration module 118 determines Shapley values for each channel over the entire training window to generate marginal contributions 212 of each model. The marginal contribution 212 represents the channel-wise proportional contribution of each channel in each transferred model 210 over the training window. The integration module 118 determines the Shapley values by considering each permutation of the transferred model 210 and calculating the difference in the model's prediction with and without the corresponding channel.

The alignment module 204 consolidates the marginal contributions 212 obtained from the independently trained transferred models into a combined prior 214. The marginal Shapley values obtained from each transferred models 210 are combined to generate the combined prior 214 that is objectively informed by each prior 120 with full coverage in terms of both channel and time.

The transfer learning model 206 then performs transfer learning on the combined prior 214 to generate a combined model 216 from the base model for downstream analysis. The integration module 118 analyzes the combined model 216 to generate final scores 220 to ensure that the combined model 216 fits the prior data well.

### Example Multiple-Prior Integration Procedure

The following discussion describes implementable techniques utilizing the previously described systems and devices. Aspects of each procedure are implementable in hardware, firmware, software, or a combination thereof. The procedures are shown as blocks that specify operations performed by one or more devices and are not necessarily limited to the orders shown for performing the operations by the respective blocks. In portions of the following discussion, reference is made to FIGS. 1 and 2.

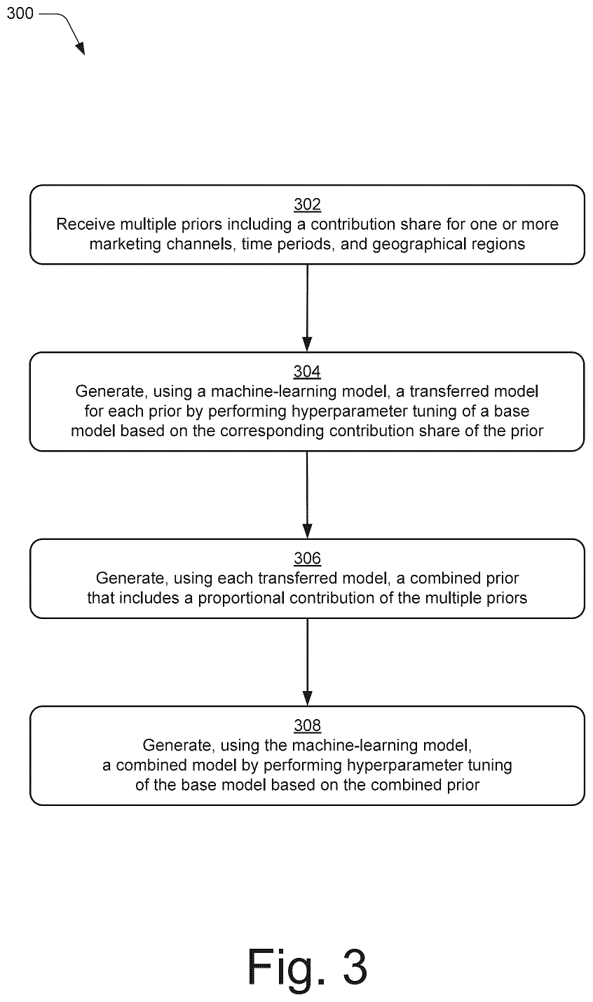

FIG. 3 depicts a procedure 300 in an example implementation of multiple prior integration in media mix modeling. To begin, a processing device receives multiple priors that include marketing data or contribution share for one or more marketing channels, one or more time periods, and one or more geographical regions (block 302). For example, the multiple priors include marketing experiments, third-party publisher reports, past modeling results, or spend-share information.

If necessary, the alignment module 204 generates an adjusted prior 208 that aligns a geographical coverage of the prior (e.g., Prior A 202-1) with the geographical coverage of the base model. An adjusted prior 208 is generated for each prior 120 by projecting the prior 120 to the larger geographical coverage. In other implementations, the alignment module 204 aligns a marketing channel coverage or a time coverage of each prior with the corresponding marketing channel coverage or the time coverage of the base model.

A machine-learning model generates a transferred model for each prior of the multiple priors (block 304). For example, the transfer learning model 206 generates the transferred models 210 by performing hyperparameter tuning of the base model based on the corresponding contribution share of each prior 120 or each adjusted prior 208. The base model includes the transfer learning model 206 generated using training contribution shares and training business assumptions to model the performance of multiple marketing channels. The hyperparameter tuning is performed by finding a balance between (1) a goodness-of-fit for each transferred model for the base model's time window and (2) the distance between marketing channel contributions predicted by the transfer learning model 206 and marketing channel contributions included in the marketing data of the corresponding prior. The balance is chosen as a value of the hyperparameter that is located on the Pareto frontier between these two objectives.

The processing device uses each transferred model to generate a combined prior that includes the proportional contribution of the multiple priors or the multiple adjusted priors (block 306). For example, integration module 118 generates the combined prior 214 by determining the Shapley values of each channel for each transferred model 210 over the base model's time window. The Shapley values are then averaged across the channels of the transferred models 210.

The machine-learning model then generates a combined model by performing hyperparameter tuning of the base model based on the combined prior (block 308). For example, the machine-learning module 116 generates the combined model 216 by performing hyperparameter tuning of the base model based on the combined prior 214. Similar to the previous transfer learning process, the transfer learning model 206 finds the balance between (1) the goodness-of-fit for the combined model 216 and (2) the distance between the marketing channel contributions predicted by the base model and combined prior 214. The integration module 118 determines Shapley values for each channel of the combined model 216, which are used to generate a marketing budget plan across multiple channels or make other marketing decisions.

### Example System and Device

FIG. 4 illustrates an example system 400 that includes an example computing device 402 that is representative of one or more computing systems and/or devices that implement the various techniques described herein. This is illustrated by including the MMM system 104, machine-learning module 116, and integration module 118 of FIG. 1. The computing device 402 is configurable, for example, as a server of a service provider, a device associated with a client (e.g., a client device), an on-chip system, and/or any other suitable computing device or computing system.

The example computing device 402, as illustrated, includes a processing system 404, one or more computer-readable media 406, and one or more I/O interface 408 that are communicatively coupled to one another. Although not shown, the computing device 402 further includes a system bus or other data and command transfer system that couples the various components from one to another. A system bus includes any one or combination of different bus structures, such as a memory bus or memory controller, a peripheral bus, a universal serial bus, and/or a processor or local bus that utilizes various bus architectures. Various other examples are also contemplated, such as control and data lines.

The processing system 404 is representative of the functionality to perform one or more operations using hardware. Accordingly, the processing system 404 is illustrated as including hardware element 410 that is configurable as processors, functional blocks, and so forth. This includes implementation in hardware as an application-specific integrated circuit or other logic device formed using one or more semiconductors. The hardware elements 410 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 406 is illustrated as including memory/storage 412. The memory/storage 412 represents memory/storage capacity associated with one or more computer-readable media. The memory/storage 412 includes volatile media (such as random access memory (RAM)) and/or nonvolatile media (such as read-only memory (ROM), Flash memory, optical disks, magnetic disks, and so forth). The memory/storage 412 includes fixed media (e.g., RAM, ROM, a fixed hard drive, and so on) and removable media (e.g., Flash memory, a removable hard drive, an optical disc, and so forth). The computer-readable media 406 is configurable in various ways, as described below.

Input/output interface(s) 408 are representative of functionality to allow a user to enter commands and information to computing device 402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 402 is configurable in various ways to support user interaction, as further described below.

Various techniques are described in the general context of software, hardware elements, or program modules. Generally, such modules include routines, programs, objects, elements, components, data structures, and so forth that perform particular tasks or implement abstract data types. The terms “module,” “functionality,” and “component” as used herein generally represent software, firmware, hardware, or a combination thereof. The features of the techniques described herein are platform-independent, meaning that the techniques are configurable on various commercial computing platforms with various processors.

An implementation of the described modules and techniques is stored on or transmitted across some form of computer-readable media. The computer-readable media includes a variety of media that is accessed by the computing device 402. By way of example, and not limitation, computer-readable media includes “computer-readable storage media” and “computer-readable signal media.”

“Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium configured to transmit instructions to the hardware of the computing device 402, such as via a network. Signal media typically embodies computer-readable instructions, data structures, program modules, or other data in a modulated data signal, such as carrier waves, data signals, or another transport mechanism. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 410 and computer-readable media 406 are representatives of modules, programmable device logic, and/or fixed device logic implemented in a hardware form that is employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employed to implement various techniques described herein. Accordingly, software, hardware, or executable modules are implemented as instructions and/or logic embodied on some form of computer-readable storage media and/or by one or more hardware elements 410. The computing device 402 is configured to implement particular instructions and/or functions corresponding to the software and/or hardware modules. Accordingly, implementation of a module executable by the computing device 402 as software is achieved at least partially in hardware, e.g., through computer-readable storage media and/or hardware elements 410 of the processing system 404. The instructions and/or functions are executable/operable by one or more articles of manufacture (for example, one or more computing devices and/or processing systems 404) to implement techniques, modules, and examples described herein.

The techniques described herein are supported by various configurations of the computing device 402 and are not limited to the specific examples of the techniques described herein. This functionality is also implementable through a distributed system, such as over a “cloud” 514 via a platform 416 as described below.

Cloud 414 includes and/or represents a platform 416 for resources 418. Platform 416 abstracts the underlying functionality of hardware (e.g., servers) and software resources of the cloud 414. Resources 418 include applications and/or data that can be utilized when computer processing is executed on remote servers from the computing device 402. Resources 418 can also include services provided over the Internet and/or through a subscriber network, such as a cellular or Wi-Fi network.

Platform 416 abstracts resources and functions to connect computing device 402 with other computing devices. The platform 416 also serves to abstract scaling of resources to provide a corresponding level of scale to encountered demand for the resources 418 implemented via the platform 416. Accordingly, in an interconnected device embodiment, the implementation of functionality described herein is distributable throughout the system 400. For example, the functionality is implementable in part on the computing device 402 and via the platform 416, which abstracts the functionality of the cloud 414.

What is claimed is:

1. A method comprising:
receiving, by a processing device, multiple priors that include a contribution share for one or more marketing channels, one or more time periods, and one or more geographical regions;
generating, for each prior of the multiple priors and using a machine-learning model, a transferred model by performing hyperparameter tuning of a base model based on the contribution share of the corresponding prior;
generating, by the processing device and using each transferred model, a combined prior that includes a proportional contribution of the multiple priors; and
generating, using the machine-learning model, a combined model by performing hyperparameter tuning of the base model based on the combined prior.

2. The method of claim 1, wherein the method further comprises:
generating, for each prior of the multiple priors, an adjusted prior that aligns a geographical coverage of the prior with the geographical coverage of the base model,
wherein generating the transferred model for each prior comprises generating, using the machine-learning model, the transferred model by performing hyperparameter tuning of the based model based on the corresponding contribution share of the adjusted prior.

3. The method of claim 2, wherein generating the adjusted prior further comprises aligning a marketing channel coverage or a time coverage of the prior with the marketing channel coverage or the time coverage of the base model.

4. The method of claim 1, wherein the multiple priors include one or more marketing experiments, third-party publisher reports, past modeling results, or spend-share information.

5. The method of claim 1, wherein the base model comprises a machine-learned model generated using a set of training contribution shares and business assumptions to model a performance of multiple marketing channels.

6. The method of claim 1, wherein the hyperparameter tuning using each prior includes finding a balance between two objectives:
a goodness-of-fit for each transferred model for a time window of the base model; and
a distance between marketing channel contributions predicted by the base model and the contribution share included in the corresponding prior.

7. The method of claim 6, wherein the balance is located on a Pareto frontier between the two objectives.

8. The method of claim 6, wherein the hyperparameter tuning using the combined prior includes finding a balance between two other objectives:
a goodness-of-fit for the combined model for the time window of the base model; and
a distance between the marketing channel contributions predicted by the base model and the contribution share included in the combined prior.

9. The method of claim 1, wherein generating the combined prior comprises:
determining, for each transferred model, Shapley values for each channel over a time window of the base model; and
determining the combined prior by averaging the Shapley values for each transferred model.

10. The method of claim 1, wherein the method further comprises:
determining, for the combined model, Shapley values for each channel over a time window of the base model.

11. The method of claim 10, wherein the method further comprises:
generating a marketing budget plan across multiple channels using the Shapley values for each channel.

12. A system comprising:
a memory component; and
a processing device coupled to the memory component, the processing device configured to:
generate, for each prior of multiple priors, an adjusted prior that aligns a geographical coverage of the prior with the geographical coverage of a base model, the multiple priors including a contribution share for one or more marketing channels, one or more time periods, and one or more geographical regions;
generate, for each adjusted prior and using a machine-learning model, a transferred model by performing hyperparameter tuning of the base model based on the contribution share of the corresponding adjusted prior;
generate, using each transferred model, a combined prior that includes a proportional contribution of the multiple priors; and
generate, using the machine-learning model, a combined model by performing hyperparameter tuning of the base model based on the combined prior.

13. The system of claim 12, wherein the base model comprises a machine-learned model generated using a set of training contribution shares and business assumptions to model a performance of multiple marketing channels.

14. The system of claim 13, wherein the processing device is configured to perform the hyperparameter tuning using each adjusted prior by finding a balance between two objectives:
a goodness-of-fit for each transferred model for a time window of the base model; and
a distance between marketing channel contributions predicted by the base model and the contribution share included in the corresponding adjusted prior.

15. The system of claim 14, wherein the balance is located on a Pareto frontier between the two objectives.

16. The system of claim 13, wherein the processing device is configured to perform the hyperparameter tuning using the combined prior by finding a balance between two objectives:
a goodness-of-fit for the combined model for a time window of the base model; and
a distance between the marketing channel contributions predicted by the base model and the contribution share included in the combined prior.

17. The system of claim 12, wherein the processing device is configured to generate the combined prior by:
determining, for each transferred model, Shapley values for each channel over a time window of the base model; and
determining the combined prior by averaging the Shapley values for each transferred model.

18. The system of claim 12, wherein the processing device is further configured to determine, for the combined model, Shapley values for each channel over a time window of the base model.

19. The system of claim 18, wherein the processing device is further configured to generate a marketing budget across multiple channels using the Shapley values for each channel.

20. A non-transitory computer-readable storage medium storing executable instructions, which when executed by a processing device, cause the processing device to perform operations comprising:
receiving, by a processing device, multiple priors that include a contribution share for one or more marketing channels, one or more time periods, and one or more geographical regions;
generating, for each prior of the multiple priors and using a machine-learning model, a transferred model by performing hyperparameter tuning of a base model based on the contribution share of the corresponding prior;
generating, by the processing device and using each transferred model, a combined prior that includes a proportional contribution of the multiple priors; and
generating, using the machine-learning model, a combined model by performing hyperparameter tuning of the base model based on the combined prior.
